(19) United States
(12) Patent Application Publication
(10) Pub. No.: US 2021/0368694 A1
(43) Pub. Date: Dec. 2, 2021

(54) Feeding Apparatuses and Methods for Plants

(71) Applicant: Douglas Paul Allard, Santa Rosa, CA (US)

(72) Inventor: Douglas Paul Allard, Santa Rosa, CA (US)

(73) Assignee: Jennifer Loyd

(21) Appl. No.: 17/332,460

(22) Filed: May 27, 2021

Related U.S. Application Data
(63) Continuation-in-part of application No. 15/840,584, filed on Dec. 13, 2017, now abandoned.
(60) Provisional application No. 62/433,604, filed on Dec. 13, 2016.

(51) Int. Cl. A01G 13/02; A01G 29/00

(52) U.S. Cl. CPC A01G 13/0268; A01G 29/00

(57) ABSTRACT

The invention provides components, structures, methods, and assemblies for applying feeding materials to plants. The invention may include a permeable structure constructed of a woven material incorporating nutrient-rich material (such as compost, fertilizers, soil amendments, soil supplements, or other material). The structure may be substantially closed around the edges and allow for the flow of water and other material therethrough to plants and surrounding vegetation.

### CROSS REFERENCE TO RELATED APPLICATIONS

This application is a continuation-in-part of U.S. patent application Ser. No. 15/840,584 filed on Dec. 13, 2017, which claims the benefit of U.S. Provisional Application No. 62/433,604 filed on Dec. 13, 2016. These prior applications, including the entire written descriptions and drawing figures, are hereby incorporated into the present application by reference their entirety.

### FIELD OF THE INVENTION

The present invention relates to components, apparatuses, and methods that are useful in the application of compost, fertilizers, soil amendments, soil supplements, and other materials to soil and plant systems to help condition the media and improve plant growth.

### BACKGROUND OF THE INVENTION

A wide variety of beneficial materials may be applied to the soil to facilitate the growth of trees, shrubs, flowers, vegetation, and other plants. Compost is an organic material that can be added to the soil to help plants grow and condition the land. Typical materials used in compost may include decomposed and recycled matter, such as leaves, branches, twigs, along with grass clippings, and food waste. Compost is known to be rich in nutrients and may be used to enhance plant growth in a wide variety of settings, such as in gardens, landscaping, horticulture, and agriculture. It may be beneficial for the land and surrounding soil, for example, as a soil conditioner or fertilizer. It also may be useful for erosion control and to help reduce sediment run-off. Fertilizers, alone or in combination with compost, may be applied to soils to supply one or more plant nutrients to promote the growth of plants. Other soil supplements and plant nutrients may be used to help deliver nutrients to plants and soil and to help improve plant and soil conditions.

Typically, landscape contractors and other users of these materials apply them by shoveling the loose material around plants. The application process may be labor-intensive. The material may be difficult to haul, transport, store, and handle, particularly onsite (e.g., at a planting, landscape, construction, or other site). Moreover, the area in which the material is applied may become untidy as a result of the disbursement of the loose material around the plant and to other areas. Loss of material can also occur when the loose material disburses around the plant; for example, during water or rain events.

In addition, the plant material is often the same or similar in color to the underlying soil. It can visually blend in with the setting around which the material is applied. As a result, a user may not easily recognize that the material has been applied to a particular plant.

Once the material is applied, it is often difficult to remove, or change, or re-use. At least some plants may benefit from the use of different materials during different growth periods. A user may desire, for instance, to use certain types of fertilizers to achieve particular results during one period (e.g., initial plant growth) and other types of fertilizers to achieve different results during another period (e.g., to promote blooming). It may also be desirable to reuse the material for different plants. For example, landscape contractors may wish to move the material from plant to plant as a construction project develops. Once the loose material is applied to the soil, however, it may settle onto the ground and blend with the top layer of the soil. It then may be difficult to remove or separate the material from the underlying soil after it has been applied to a particular plant.

Accordingly, there exists a need for a delivery system that addresses many or all of the foregoing problems, including a delivery system that can effectively apply soil and plant enhancing materials, such as compost, fertilizers, soil amendments, soil supplements, and other materials, to the soil and plants. There also exists a need for a plant feeding system to facilitate the installation of gardens and plant growth in an area.

### BRIEF SUMMARY OF THE INVENTION

Among its features, the present invention describes improved assemblies and methods for applying soil and plant enhancing materials, such as compost, fertilizers, soil amendments, soil supplements, soil conditioners, and other matter, to soils, plants, planting containers, and other types of planting areas. Improved assemblies and methods for introducing and maintaining plants and other vegetation to an area are also disclosed.

In one embodiment, an apparatus comprises a substantially permeable woven enclosure comprising an interior cavity and an inner edge. The inner edge defines an inner opening that is adapted to fit around the base of a plant. The apparatus also may comprise plant material disposed within the interior cavity. The plant material may comprise at least one of the following: compost, fertilizer, and soil amendment. The woven enclosure may be filled to approximately 80% of its capacity by volume. The woven enclosure may be filled to at least 80% of its capacity by volume. In a preferred embodiment, the woven enclosure may comprise a substantially circular ring, and the inner edge defines a substantially circular inner space within the ring. The woven enclosure may comprise end segments that are separable along radial portions of the ring. The woven enclosure may comprise a biodegradable material. In addition, in some embodiments, the woven enclosure may further comprise an outer edge and a skirt descending from the outer edge. The skirt may comprise complementary fastening mechanisms adapted to secure the skirt around a planter.

In other embodiments, an apparatus comprises a substantially permeable enclosure comprising a ring-shape with an interior cavity and two substantially sealed ends aligned along a radial length of the ring-shape to form a radial separation. The apparatus also comprises plant material disposed within the interior cavity of the enclosure.

In yet other embodiments, a method for introducing material around the base of a plant comprises the steps of fitting a substantially permeable woven enclosure around a base of the plant and aligning the ends of the woven enclosure to position the enclosure around the base of the plant. The woven enclosure comprises a ring with an interior cavity and an inner opening defined by an inner edge of the ring, two substantially sealed ends aligned along a radial length of the ring to form a radial split in the ring, and plant material disposed within the interior cavity of the woven enclosure.

Also described is a substantially permeable woven enclosure comprising an interior cavity and two substantially aligned ends. An inner edge of the woven enclosure defines an inner opening and is dimensioned to wrap around the base of a plant. In some embodiments, the woven enclosure may include plant material within the interior cavity.

In addition, an apparatus may comprise a substantially permeable woven enclosure that defines a ring-shape with an interior cavity and plant material disposed within the interior cavity of the woven enclosure. The woven enclosure may comprise an inner opening and two substantially sealed ends aligned along a radial length of the ring-shape to form a radial split. The woven enclosure may be dimensioned to fit around the base of one or more plants. The plant material may comprise at least one of the following: compost, fertilizer, and soil amendment. In some embodiments, the ring-shape comprises a substantially curved peripheral edge. The ring-shape may comprise at least one substantially straight peripheral edge. The woven enclosure may comprise a biodegradable material, such as burlap material. The ends of the ring-shape may be detachably sealed. The woven enclosure may be filled to approximately 80% of its storage capacity by volume. In some embodiments, the woven enclosure may be filled to at least 80% of its storage capacity by volume.

Also disclosed is a method for introducing material around the base of a plant. The method comprises the steps of fitting a substantially permeable woven enclosure around a base of the plant; placing the base of a plant through the inner opening of the woven enclosure; and aligning the ends of the woven enclosure around the base of the plant. In some embodiments, the step of aligning the ends of the woven enclosure comprises overlapping the two sealed ends. In another embodiment, the step of aligning the ends of the woven enclosure comprises placing one sealed end adjacent to the other sealed end. In yet another embodiment, the step of aligning the ends of the woven enclosure comprises positioning the sealed ends to allow for a gap between the sealed ends.

In addition, an apparatus is described for feeding a plant comprising an outer casing, an inner casing, and planting media. The outer casing comprises an interior cavity and an outer casing opening disposed at an end of the outer casing and providing access into the interior cavity. The inner casing is disposed within the interior cavity of the outer casing. The planting media is disposed within the inner casing. The outer casing opening permits removal of the inner casing from the interior cavity, while leaving the planting media within the interior cavity. In some embodiments, the inner casing may comprise an inner casing opening disposed at an end of the inner casing opposite from the outer casing opening, and the inner casing opening permits release of the planting media from the inner casing. The outer casing may further comprise a closure member disposed at the end of the outer casing. The outer casing may comprise a substantially tubular shape. The outer casing may comprise a substantially ringed shape. The outer casing may also comprise a substantially water permeable enclosure. The planting media may comprises at least one of the following: compost, fertilizer, or soil.

Also described is an apparatus for feeding a plant comprising an outer enclosure and an inner enclosure. The outer enclosure comprises an interior cavity and an access opening at an end of the outer enclosure and providing passage into the interior cavity. The inner enclosure is dimensioned to fit through the access opening and within the interior cavity of the outer enclosure, and the inner enclosure comprises a release opening at an end of the inner enclosure. In some embodiments, the apparatus may further comprise planting media disposed within the inner enclosure. The inner enclosure may be fit within the interior cavity of the outer enclosure, and the release opening may be positioned opposite from the access opening. The inner enclosure may be fit within the interior cavity of the outer enclosure, and the inner enclosure may be adapted to be removed from the interior cavity, while leaving the planting media within the interior cavity via the release opening. The outer enclosure may further comprise a closure member disposed near the access opening of the outer enclosure. The outer enclosure may comprise a substantially tubular shape. The outer enclosure may comprise a substantially ringed shape.

In addition, a method of feeding plants comprises the step of securing a feeding assembly, wherein the feeding assembly comprises a first end, a second end opposite from the first end, an outer casing aligned with the first and second ends of the feeding assembly and comprising an interior cavity, an inner casing disposed within the interior cavity and aligned with the first and second ends of the feeding assembly, and planting media disposed within the inner casing. The method also comprises the steps of opening the inner casing at the first end of the feeding assembly to permit release of the planting material from the inner casing; and opening the outer casing at the second end of the feeding assembly to permit removal of the inner casing from the feeding assembly. The method further comprises the steps of removing the inner casing from feeding assembly through the opened outer casing, while releasing the planting media through the opened inner casing and into the interior cavity of the outer casing; and positioning the feeding assembly with released planting media in a desired area.

In some embodiments, the feeding assembly may comprise a substantially tubular shape. The feeding assembly may comprise a substantially ringed shape. The feeding assembly may further comprise a closure member adapted to substantially close the outer casing at the second end. The method may further comprise the steps of opening the outer casing at the first end to permit the opening of the inner casing, and closing the outer casing at the first end after the inner casing has been opened. The planting media may comprise at least one of the following: compost, fertilizer, or soil.

### BRIEF DESCRIPTION OF THE DRAWINGS

Embodiments of the present invention may be described with reference to the accompanying drawings.

FIG. 1 illustrates an angled top view of a feeding device fitted around the base of a tree in accordance with an embodiment of the present invention.

FIG. 2 illustrates a top view of a feeding device in accordance with an embodiment of the present invention. In this illustration, the ends of the feeding device are positioned so that they are separated by a space.

FIG. 3 illustrates a top view of a feeding device in accordance with an embodiment of the present invention. In this illustration, the ends of the feeding device are positioned so that they overlap, and the feeding device forms a substantially closed ring-shape.

FIG. 4 illustrates an angled side view of the feeding device shown in FIG. 3.

FIG. 5 illustrates an angled side view of a feeding device with a skirt. In this illustration, the feeding device is placed over a planter in accordance with an embodiment of the present invention.

FIG. 6 illustrates an angled side view of a feeding device with a skirt in accordance with an embodiment of the present invention. In this illustration, the feeding device is placed over a planter, and the skirt includes a plurality of ties to wrap opposite sides of the skirt around a planter.

FIG. 7 illustrates an angled top view of a feeding device with a skirt fitted over a planter in accordance with an embodiment of the present invention. In this illustration, a watering hose is used to deliver water through the feeding device and to the plant.

FIG. 8 illustrates an angled top view of a feeding device fitted around the base of a tree in accordance with an embodiment of the present invention.

FIG. 9 illustrates an array of feeding devices of different sizes in accordance with different embodiments of the present invention.

FIG. 10 illustrates schematically feeding devices used for different plant pot sizes in accordance with different embodiments of the present invention.

FIG. 11 illustrates schematically an angled bottom view of components of a feeding device that includes filler media housed within an inner liner.

FIG. 12 illustrates schematically an angled side view of a feeding device with an inner liner.

FIG. 13 illustrates schematically an angled bottom view of an end of a feeding device with an inner liner.

FIG. 14 illustrates schematically an angled bottom view of an end of a feeding device with an inner liner.

FIG. 15 illustrates schematically an angled side view of an inner liner that includes filler media.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the phrase “at least one of the following: A, B, or C” should be understood to mean one or more of the listed elements is true (or present). For example, “at least one of the following: A, B, or C” is satisfied by any one of the following: only A is true (or present), only B is true (or present), only C is true (or present), any sub-combination of the elements is true (or present), or all of A, B, and C are true (or present). As used herein, the phrase “at least one of the following: A, B, and C” should be understood to mean one or more of the listed elements is true (or present). For example, “at least one of the following: A, B, and C” is satisfied by any one of the following: only A is true (or present), only B is true (or present), only C is true (or present), any sub-combination of the elements is true (or present), or all of A, B, and C are true (or present).

Also, use of the terms “a” or “an” are employed to describe elements and components of the invention. This is done merely for convenience and to give a general sense of the invention. This description should be read to include one or at least one, and the singular also includes the plural unless it is obvious that it is meant otherwise.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless otherwise defined, all technical and scientific terms used herein have the same meaning as commonly understood by one of ordinary skill in the art to which this invention belongs. Although methods similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and not intended to be limiting.

In the following description, numerous specific details are provided, such as the identification of various system components, to provide an understanding of embodiments of the invention. One skilled in the art will recognize, however, that embodiments of the invention can be practiced without one or more of the specific details, or with other methods, components, materials, etc. In still other instances, well-known structures, materials, or operations are not shown or described in detail to avoid obscuring aspects of various embodiments of the invention.

### Feeding Devices

Feeding devices that may be placed at the base of one or more trees, shrubs, vegetation, flowers, potted plants, or other plant life are described. The feeding device may allow the application and removal of soil and plant enhancing materials, such as compost, fertilizers, soil amendments, soil supplements, or other materials to the plant or soil. Among its potential advantages, the feeding device may facilitate the application of the materials to the soil, topsoil, and/or underlying plant structures. It may also help to retain moisture at the base of the plant. The feeding device may help to reduce or eliminate erosion of materials at the base of the plant. In addition, the placement of the feeding device at the base of one or more plants may offer visible evidence of feeding. In preferred embodiments, the device may be made entirely, or in part, of biodegradable materials to allow the feeding device to be left in place, if desired, at a landscape site.

The feeding device may be useful for the application of soil and plant enhancing materials, feeding, and maintenance of a wide variety of plant life in a wide variety of settings. The feeding device may help in the application of a wide variety of different composts, fertilizers, soil, amendments, soil supplements, and/or other matter to enhance the growth of plants and improve the condition of the land or the surrounding soils (e.g., in a pot or other growing container) in a wide variety of settings. For example, the feeding device may be useful during the course of site construction to enhance new plant growth and then be moved from plant to plant as the project develops. The device may be useful in commercial or personal gardens for vegetation and/or flowering plants. The feeding device also may be useful to allow for feeding, including the targeted feeding, of potted plants in nurseries or in home settings.

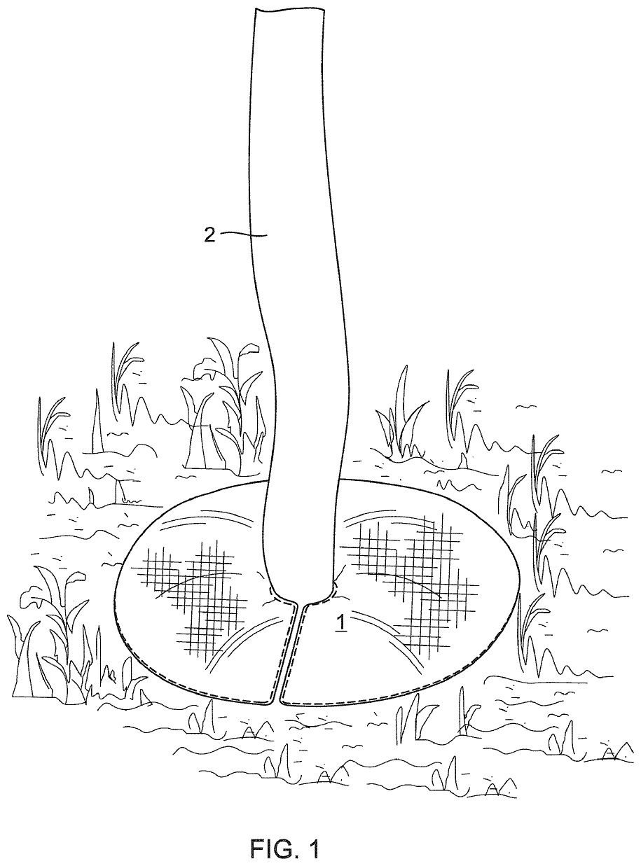

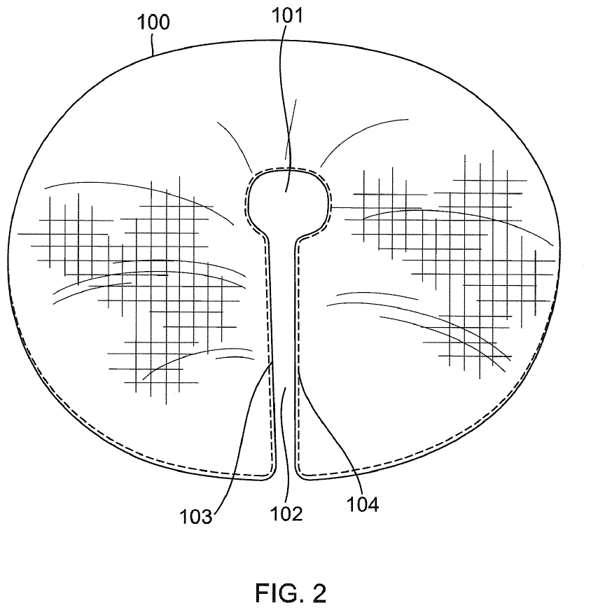

In one embodiment, the device may be placed at the base of a tree around its trunk. Referring to FIG. 1, a substantially ring-shaped bag 1 has a substantially hollow interior. The interior of the bag may be filled with material, e.g., fertilizer or compost material, and positioned around the base of a tree trunk 2. As shown in FIG. 2, the bag 100 may comprise a substantially circular ring shape that includes a substantially circular central opening 101 and end segments. An opening 102 that extends along a radial direction of the ring is formed from two closed ends of the bag 103 and 104. The radial opening provides for an adjustable separation that allows for the insertion and positioning of the bag around a plant. The bag may be removed after the initial placement of the bag around the plant by sliding the plant or a portion of the plant through the radial opening of the bag.

An amount of compost, fertilizer or other material may be placed in the bag, and the ends of the bag may be fully or at least partially sealed to reduce loss of material at the ends. The bag may be fabricated in any multitude ways known in the art for constructing fabric devices. For example, pieces of material may be sewn together along its edges. Moreover, it will be appreciated that the ends of the feeding bag may be sealed using one or more of any closure structures and/or methods known in the art for securing material within woven fabric, including, without limitation: sewing, stitching, stapling (e.g., with mild steel staples), Velcro, hooks, snaps, glue, interconnecting parts, ties, string, twine, hook and loop fasteners, other fasteners, elastic, tensioners, locks, latches, complementary grooves and notches, protrusions, pegs, adhesives, glues, pins, buttons, snaps, snap-in connectors, twist-on fittings, hooks, screws, mechanical fittings, other mechanical connections, and/or other connecting structures and connecting methods. In a preferred embodiment, the ends of the feeding bag may be re-sealable to facilitate the removal of the filler media and the subsequent refilling and reuse of the bag.

In a preferred embodiment, the bags are vacuum-sealed to reduce the air content inside and to help retain moisture after the filler media is placed inside. The vacuum sealing may help to extend the shelf life of the filler media. It may also help to remove oxygen to reduce degradation of the bag material and preserve the bag material (for instance, burlap or other organic fabric) so that it may be used for longer periods of time.

When using the feeding bag for a tree or other plant, the user may position the bag around the base of the tree or plant. The ends of the bag are pulled apart. The ends of the bag are moved past the tree trunk (or stem or base of the plant) along the radial opening until the tree trunk (or stem or base of the plant) is substantially positioned in the central opening. The ends of the bag are then pulled together so they are substantially aligned to allow the bag to form a loop or band that is has a substantially ring shape.

During watering events, water flows through the bag, carrying the nutrients and other feeding material from the bag to the plant roots, soil, and/or other underlying structures. The bag may be removed from the plant and re-installed, to allow for changing of seasonal fertilizers and/or use with other plants. It may also help to retain moisture at the base of the plant, thereby allowing for water conservation. The bag may also offer visible evidence of feeding, to allow users to identify those plants to which the feeding material has already been applied. If desired, the used bag may be cut open and the feeding material spread along a landscaped area to enhance the landscape.

In some embodiments, the feeding device may be positioned so that the internal contents of the device are not in direct contact with the underlying soil. As a non-limiting example, the feeding device may be set on top of the soil such that the filler media is not in direct contact with the soil. As another example, the feeding device may be set on a gravel bed or other raised bed. These configurations may allow water, as it percolates through the filler material (e.g., compost, fertilizer, soil amendment, or other material) to mix with the ambient air. The introduction of the air, including the oxygen contained in the air, may help to enhance the performance of the filler material.

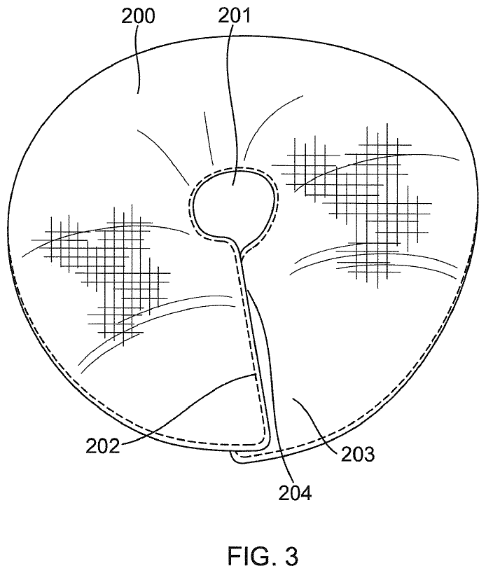

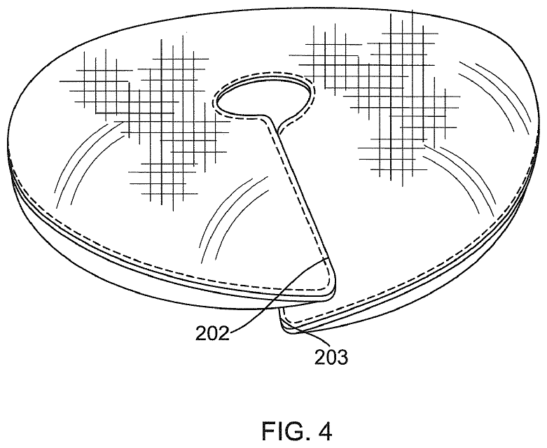

FIGS. 3 and 4 illustrate a feeding device in accordance with an embodiment of the present invention. A woven enclosure 200 forms a substantially circular shape that may be fitted around the base of a tree trunk. The enclosure has a central opening 201 and end segments 202 and 203 that may be pulled apart to form an opening 204 along a portion of its radius, and fitted together again. As shown in FIG. 4, the end segments of the bag may be overlapped such that a portion of one end segment 202 may hang over a portion of the other end segment 203. This overlapping configuration may help to secure the woven enclosure around the tree trunk or base of other plants.

It will be appreciated that the end segments may be fitted so they are in contact with each other. The end segments may be overlapped (as shown in the woven bag of FIG. 4) or placed such that the edges are adjacent to each other. Alternatively, the end segments of the feeding device may be fitted so they are at least partially wrapped around the base of the desired plant but not in direct contact with each other.

In some embodiments, the end segments of the feeding device may be fitted around the base of a plant using optional connecting apparatuses that are known in the art to connect woven materials (not shown), including without limitation: mechanical connections, interconnecting parts, ties, string, twine, hook and loop fasteners, other fasteners, Velcro, elastic, tensioners, locks, latches, complementary grooves and notches, protrusions, pegs, adhesives, glues, pins, buttons, snaps, snap-in connectors, twist-on fittings, hooks, screws, mechanical fittings, or other connecting structures and connecting materials.

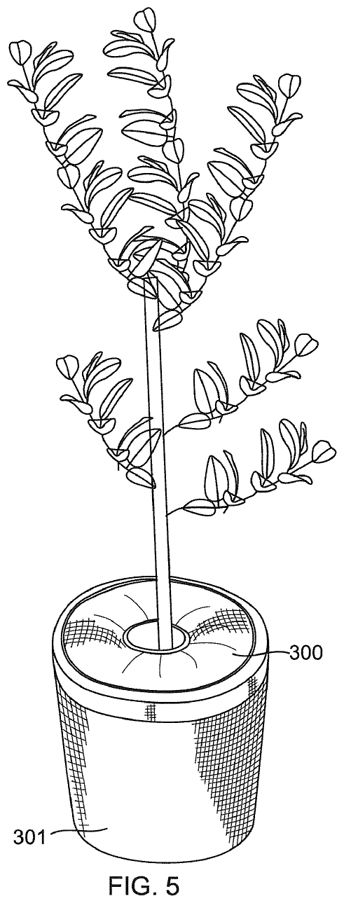

Another embodiment of the feeding device is shown in FIG. 5. The feeding device includes a substantially circular ring along an upper portion 300. It also includes fabric extending from the edges of the ring and descending along a lower portion of the device to form a skirt 301. The device may be placed over a planter, for example, a standard industry cylindrical plastic planter, for the purpose of the improving the planter appearance and adding water retention and fertilization capabilities. The ring may incorporate compost, fertilizers, soil amendments, soil supplements, or other material known to enhance plant growth. In other embodiments, such as in applications where only water retention and/or erosion control is desired, the ring may be used without planting material in the interior of the device.

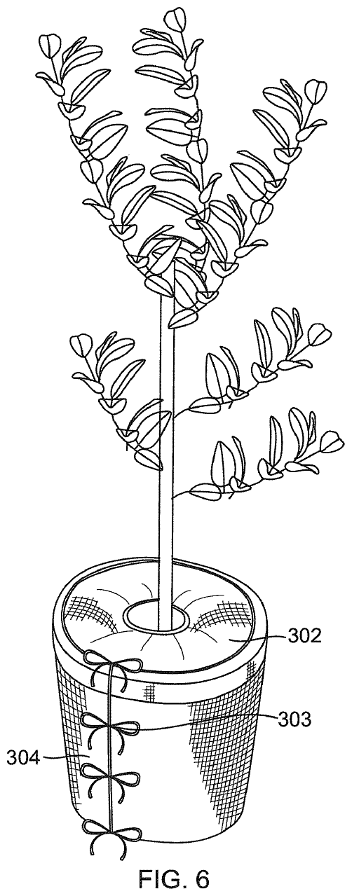

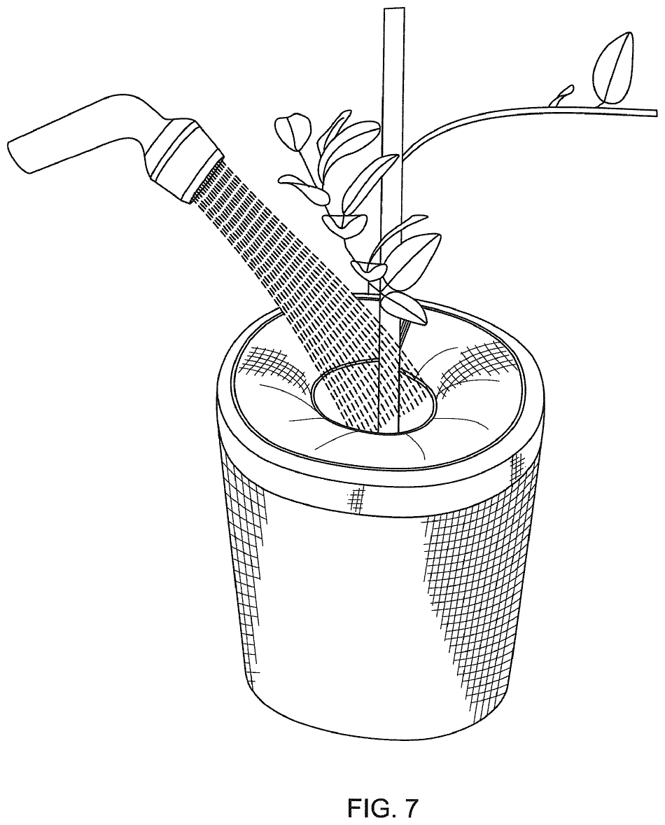

The skirt includes one or more flaps of fabric that can be wrapped around a planter using mechanisms known in the art for securing ends of fabric together. In the embodiment of FIG. 6, the feeding device has a substantially circular ring along an upper portion 302 with skirt segments 303 and 304. The skirt is positioned around a planter and the skirt segments are secured around the planter using a set of complementary ties positioned vertically along a side of the device. As shown in FIG. 7, water can be delivered to the plant through the top of feeding device. The ring and skirt portions of the device may be constructed of a unitary piece of fabric; for example, a permeable woven material. In other embodiments, the ring and skirt portions of the device may be constructed of multiple, separate pieces of fabric that are connected together and fitted around a plant or plant-housing structure.

It will be appreciated that in some embodiments the ring of the feeding devices described above may be formed from a substantially closed ring that may be fitted around a plant, including a potted plant or vegetation or other plant-life that is planted in the ground. For example, for a potted plant, the ring section of the device may be formed from a substantially continuous ring and fitted around the lip of the pot. An optional skirt may extend from the outer edges of the ring to cover the sides of the pot. The skirt may include open-end segments that are placed around the sides of the pot, and the open-end segments may be secured together (e.g., by securing complementary ties or other connection mechanisms). In other embodiments, the skirt may form a continuous bag that wraps around the sides of the pot. In yet other embodiments, a ring-shaped feeding device may include a continuous ring with a central opening that is used for vegetation planted in the ground. The ring is positioned around the base of the plant in the ground by lowering the ring to the ground with the base of the plant fitting within the central opening of the ring. In other embodiments, a feeding device may include a ring with multiple separations that may be positioned around one or more plants.

### Materials Used for Construction

The feeding device may be constructed of any material having openings sized to allow for water flow through the material, while retaining all or at least most of the compost, fertilizer, soil amendments, soil supplements, or other feeding matter within the device. It also may be desired that the feeding device material have sufficient strength, as may be determined by a variety of different indicators, including without limitation tear strength and bursting strength (e.g., as measured by Mullen Burst, puncture, or other testing). For example, the feeding device may be constructed of one or more woven geotextile materials. In some embodiments, the feeding device may be constructed of a material with natural fibers that are biodegradable.

In a preferred embodiment, the feeding device may be constructed of a biodegradable woven fabric, such as burlap, also known as jute or Hessian. The burlap material may comprise, for example, a 10-ounce burlap fabric. Because of its tendency to absorb water, this type of burlap material may help to retain moisture at the base of the tree. In some applications, the feeding device alternatively may be constructed of non-biodegradable materials, which may be desirable in applications that allow for extended use, and/or maintenance, or those that call for extended re-use of the feeding device.

The ordinary artisan will recognize that other materials commonly used in applications involving plant maintenance, soil enhancement, and erosion control can be employed in the present invention. Other types of material include, without limitation: 7-ounce burlap, other types of burlap, cotton, cotton blends, cheesecloth material, hemp, other woven fabrics, plastic netting, mesh, polypropylene material, high density polyethylene material, or other materials known in the art for retaining compost, fertilizer, soil amendments, or other feeding matter. Generally any other materials that can allow water flow and retention of at least some of the soil and plant enhancing material may be used. The selection of the material may vary depending on factors such as, without limitation: the desired weave count, mesh size, strength, longevity, permeability, volume of anticipated filter material, storage capacity, the anticipated application, and/or the desired size of the feeding device.

The feeding device may be fabricated, and the material formed into the desired shape, using one or more of any methods and connecting structures known in the art for connecting woven fabrics and materials. These include, without limitation: sewing, stitching, weaving, stapling (e.g., with mild steel staples), gluing, using fasteners, hooks, snaps, glue, other mechanical connections, interconnecting parts, ties, string, twine, hook and loop fasteners, elastic, tensioners, locks, latches, complementary grooves and notches, protrusions, pegs, adhesives, glues, pins, buttons, snaps, snap-in connectors, twist-on fittings, hooks, screws, mechanical fittings, knotting, or other connecting structures and connecting methods.

### Filler Media

It will be appreciated that the feeding devices of the present invention may be designed to incorporate a wide variety of filler media useful in the feeding, maintenance, growth, and care of soil and plants. In some embodiments, the feeding devices may include compost, for example, general use composts, one of many available compost materials that have been approved by government and regulatory agencies for use in landscape projects, or custom-designed compost blends.

In other embodiments, the feeding device may include fertilizers that target plant growth and/or bloom growth, for example organic fertilizers or non-organic fertilizers. In preferred embodiments, different feeding devices (or the same feeding devices filled with different filler media) may be used to apply material to the same plant and staged, depending on the season or desired plant growth. For example, a feeding device with fertilizer material directed to plant growth may be applied to promote plant growth during one or more early growth periods (e.g., as a “growth ring”). A feeding device with fertilizer targeting bloom growth may be applied to promote flowering (e.g., as a “bloom ring”).

Other materials useful in the care of plants may be used as well. As a non-limiting example, the feeding devices of the present invention may be treated with or otherwise include repellant or insecticides. A feeding device treated in this way may be used to deter deer, other wildlife, or insects from consuming plants. In some embodiments, the feeding device may include planting soil, engineered soil blends, or other types materials to help the growth of plants. In yet other embodiments, the feeding device may include bioretention media to help with erosion control.

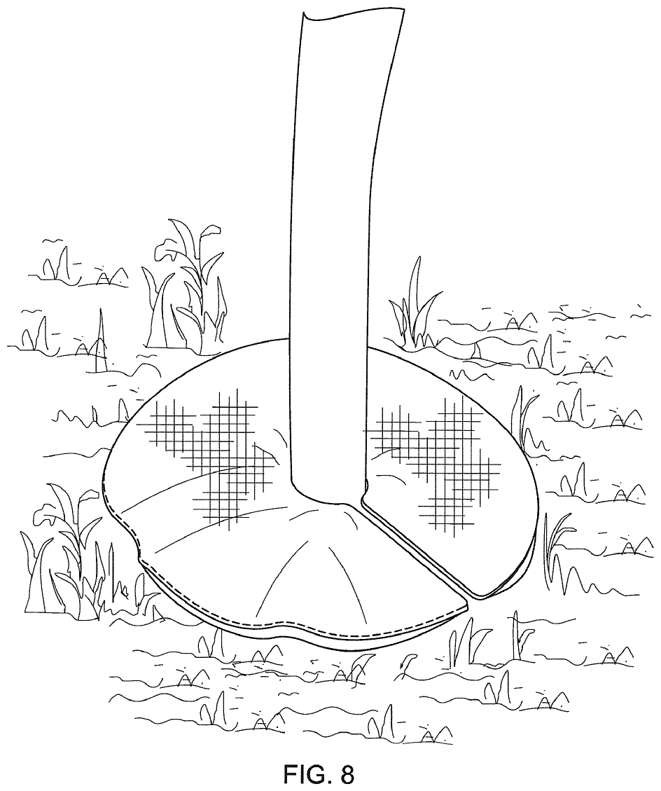

The amount of filler material used in the feeding device may depend on factors such as: the desired flexibility of the feeding device, the ability to conform to the ground, pliability, permeability, anticipated water flow rates, and/or the overall desired weight. In some embodiments, the feeding device may be filled loosely to allow it to flexibly conform to the ground and be capable of being shaped around the base of a tree. As a non-limiting example, the feeding device may be filled to approximately 80% of its storage capacity by volume. The feeding device may be filled to at least 80% or more of its storage capacity by volume. In other embodiments, the feeding device may be loosely filled (as depicted in FIG. 8) to allow for more flexibility.

### Shapes and Sizes

It also will be appreciated that the feeding device may be constructed in a variety of sizes, shapes, and configurations, depending on the desired applications. Referring to FIG. 8, an embodiment of the present invention is shown. A feeding bag includes a disc-shaped woven pillow within which feeding material may be contained. The pillow defines a substantially circular disc shape with adjustable end segments. The pillow includes a substantially round outer circumference and an inner opening. Adjoining end segments may be separated to form a gap that extends along a portion of the radius of the circle.

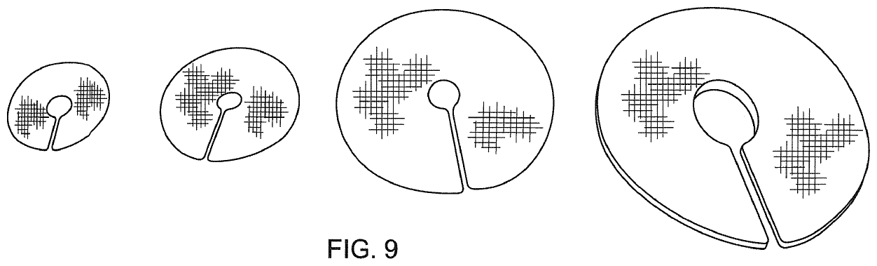

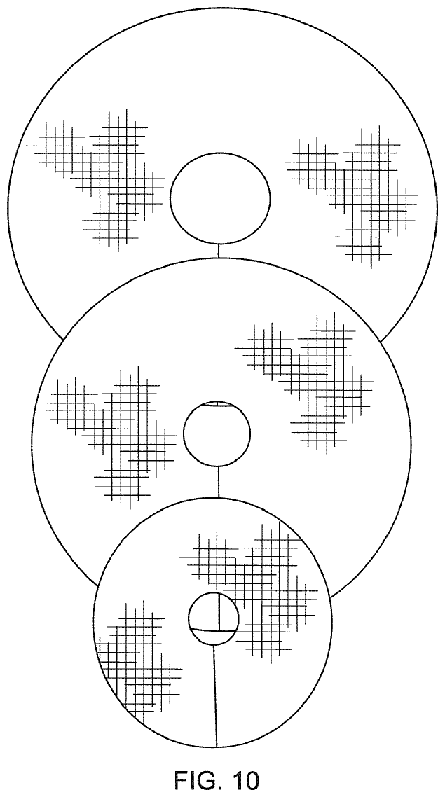

In one embodiment, the substantially circular feeding device may have a diameter of approximately 30″ to accommodate plants that are grown in 30-gallon pots. This size may be useful for large trees and plants, for example, in industrial applications. The feeding device of the present invention may alternatively be sized to allow for use with smaller trees, flowers, shrubs, or other plants. In another embodiments, the feeding pillow may have a diameter of approximately 8″ for use with plants that are grown in 1-gallon pots. This size may be useful for residential use or use with smaller plants. A non-limiting chart showing sizes for circular feeding devices and common plant sizes is shown below (and in FIGS. 9 and 10).

| Size of Potted Plant | Size of Circular Feeding Device |
|---|---|
| 30-gallon | 30” diameter |
| 25-gallon | 24” diameter |
| 5-gallon | 12” diameter |
| 1-gallon | 8” diameter |

These sizes and shapes and plant types (e.g., potted plants) are provided for illustrative purposes only. The feeding devices of the present invention may be constructed of any size and shape to accommodate numerous types of trees, flowers, vegetation, potted plants, other plants, and landscape features. The shapes, sizes, and dimensions of the feeding devices of the present invention can vary depending on factors, such as, without limitation: the desired storage volume, the anticipated water flow rates, the filler media used in the devices, materials used for construction, and the plants and landscape features with which the devices are used. The feeding devices of the present invention may also be used with other types of plants, including without limitation, trees, shrubs, blooming plants, plants that have been established and are growing in the ground, and newly planted trees, shrubs, or other plant-life.

In some embodiments, the feeding device may have one or more substantially inner and/or outer straight edges to accommodate different types of planter shapes or landscape features (e.g., substantially square, substantially rectangular, substantially hexagonal, substantially octagonal, irregular shapes, or other shapes); or a combination of straight and curved edges. It is also contemplated that ring-shape planters, such as those described above, may define a substantially square, substantially rectangular shape, or other polygonal shape. The feeding device may include more than one inner opening to accommodate multiple plants. The shapes and sizes of the inner openings may also be customized to fit around different plants and landscape features.

Feeding Device with Inner Liner

In some embodiments, the feeding device may incorporate one or more inner liners. The inner liner may be filled with a variety of filler media, such as soil, compost, fertilizers, soil amendments, soil supplements, potting mix, planting mix, seeds, other plant growing media, or a combination thereof, and fit within an interior portion of the feeding device. The incorporation of an inner liner into a feeding device may be useful to help protect the feeding device; for example, to protect the feeding device from degradation caused by the accumulation of moisture in the planting material or other filler media placed within the device. The inner liner may be useful in preserving the plant material or other filler media by providing a barrier between the filler media and the outside elements. The inner liner also may be advantageous in prolonging the shelf-life of the feeding device; for example, by preserving the feeding device material (such as, without limitation, burlap or other biodegradable fabric) so that the feeding device may be used for longer periods of time.

In some embodiments, a feeding device includes a substantially ring-shaped planting sleeve that incorporates an inner liner. The inner liner may comprise a plastic casing or other type of flexible casing material. The inner liner may be dimensioned to fit within the interior of a ring-shaped planting sleeve. The inner liner may be at least partially filled with filler media, such as soil, compost, fertilizers, soil amendments, soil supplements, potting mix, planting mix, seeds, other plant enhancing media, or a combination of plant enhancing media. In preferred embodiments, the inner liner includes one or more sealable portions that allow for the incorporation and release of the filler media. For example, a portion of the inner liner may be opened to allow for the incorporation of filler media. The portion then may be at least partially closed to hold the filler media within the inner liner.

The planting sleeve may also include one or more sealable portions that provide access to the inner liner (and the filler media disposed within the inner liner). For example, an end of the planting sleeve may be opened, and the inner liner may be fit within the planting sleeve at the opened end. After the inner liner has been fit within the planting sleeve, the opened end of the surrounding planting sleeve may be at least partially closed to hold the inner liner (and filler media) until the planting sleeve is ready for use.

When the planting sleeve (fitted with the inner liner) is ready to be used, the inner liner may be removed from the planting sleeve, for example, by opening two ends (each opposite from the other) of the planting sleeve. At one opened end of the planting sleeve, an opening may be cut at or near the corresponding end of the inner liner. The inner liner may be pulled through the other opened end of the planting sleeve, leaving the planting material within the planting sleeve. The ends of the planting sleeve also may be substantially closed, and the planting sleeve with substantially closed ends may be used to support the growth of plants.

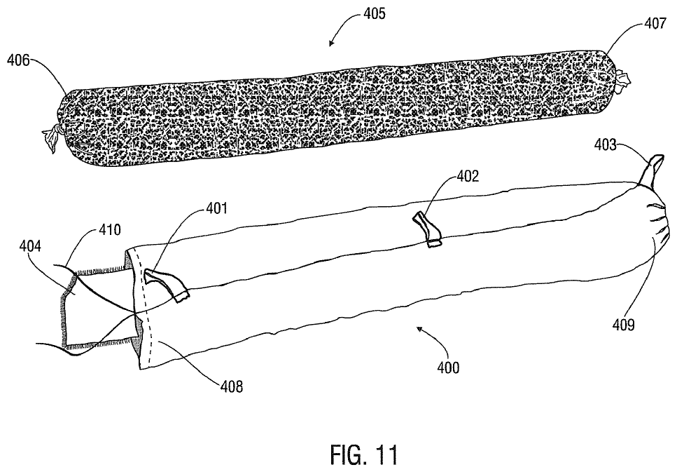

It will be appreciated that the inner liners, planting sleeves, feeding bags, and other feeding devices described herein are not limited to ring-shaped devices and may comprise a variety of different shapes and sizes. FIGS. 11-14 illustrate embodiments of an inner liner used with an enclosure that forms a substantially tube-shaped planting sleeve.

As shown in FIG. 11, the planting sleeve 400 may comprise a flexible material that may be extended to form an elongated tube-shape with a hollow interior. Installation hoops 401, 402, and 403 located on an outside of the planting sleeve may be used to help position the planting sleeve in various settings; for example, the installation hoops may help position the planting sleeve along a desired planting surface, facilitate irrigation line placement, and/or help secure stacked installations. One or more flaps, such as flap 404, may be located at one or more ends to help reduce loss of material at one or more ends of the planting sleeve.

Inner liner 405 comprises a substantially tube-shaped plastic or other casing material that may be extended to form an elongated body portion that extends along a length of the casing. The substantially tube-shaped casing is dimensioned to fit within the hollow interior of the tube-shaped planting sleeve. The inner liner is dimensioned such that, when the interior of the inner liner is at least partially filled with planting mix or other plant-enhancing material, the body portion of the inner liner may be fit along a length of and within the hollow interior of the tube-shaped planting sleeve.

The inner liner may include an end with at least one opening that extends into the interior of the inner liner. The opening may allow for the filling of the inner liner with planting material. In preferred embodiments, the inner liner includes at least two openings, each at an opposite end of the liner. To fill the inner liner, an end of the inner liner 406 may be at least partially sealed (e.g., by tying a knot or using one or a combination of other closure mechanisms) to reduce loss of material at the end. Planting material then may be placed in the inner liner at an opposite end. Once the inner liner has been filled with the desired amount of material, this opposite end of the inner liner 407 may be sealed in the same manner as the first end (e.g., by tying a knot or using one or a combination of other closure mechanisms).

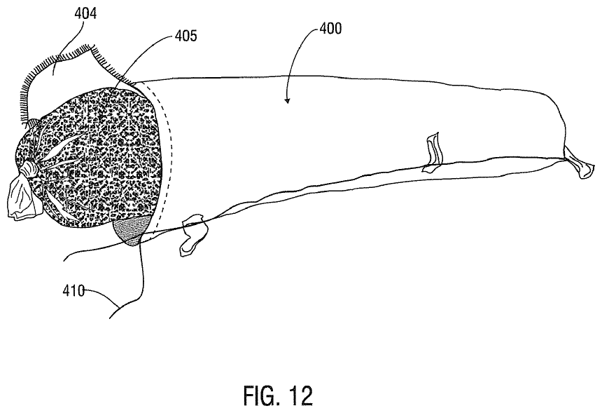

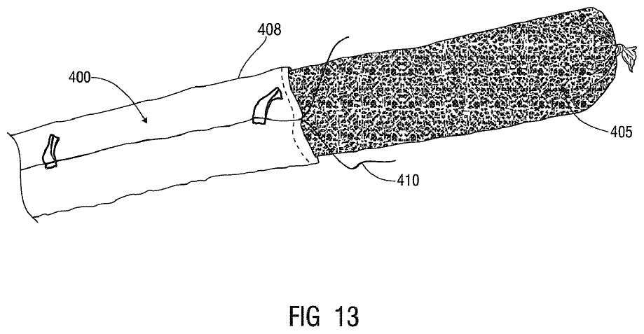

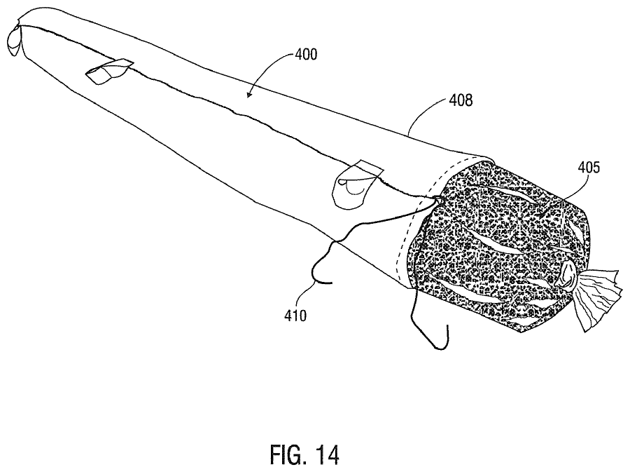

The planting sleeve also may include an end with at least one opening that extends into the interior of the planting sleeve. Planting sleeve 400 includes end segments 408 and 409 on opposite ends of the planting sleeve. Each of the end segments may be opened to allow access into the interior of the planting sleeve. The flap at one of the end segments may be lifted to allow for the insertion of the inner liner, pre-filled with planting material, as shown in FIG. 12. The inner liner may be inserted into the opened end and through the hollow interior of the planting sleeve, as further shown in FIGS. 13 and 14. Once the inner liner has been fit within the planting sleeve, the opened end segment of planting sleeve may be closed using one or more twine closure ties 410 or other closure structures known in the art to secure material used for feeding plants. In this example, the closure flap (shown in FIGS. 11 and 12) may be inserted over the end of the inner liner, and the end of the planting sleeve may be cinched or otherwise sealed using the closure tie. The pre-filled planting sleeve then may be transported or stored for later use.

When the planting sleeve is ready to be used, the inner liner may be removed from the planting sleeve and the planting material released from the inner liner. To remove the inner liner, a user may open an end of the planting sleeve, exposing the filled inner liner. An opening may be formed at the corresponding end of the inner liner (e.g., by cutting off the end, untying the tied knot, or otherwise unsealing the opening), and the planting sleeve may be closed over this opened end using a twine closure tie or other closure mechanism. An opposite end of the planting sleeve may be opened, exposing the opposite closed end of the inner liner. The inner liner may then be pulled out of this opposite end of the planting sleeve, leaving the planting material within the interior of the planting sleeve. The remaining open end of the planting sleeve is at least partially sealed (e.g., the closure flap is inserted over the planting material and the end closed using the closure tie or other closure mechanism), retaining the planting material so that it is ready for use.

In preferred embodiments, the inner liner may be dimensioned to fit within a tube-shaped planting sleeve that is approximately 3.5 feet long and about 6 inches in diameter to facilitate transport and handling. As another non-limiting example, the inner liner may be dimensioned to fit within a tube-shaped planting sleeve that is approximately 8 feet long and approximately 6 inches in diameter to provide more area coverage. These sizes and shapes are provided for illustrative purposes only. The feeding devices with the inner liner may be constructed of any size and shape to accommodate numerous types of trees, flowers, vegetation, potted plants, other plants, and landscape features. The shapes, sizes, and dimensions of the feeding devices can vary depending on factors, such as, without limitation: the desired storage volume, the anticipated water flow rates, the filler media used in the devices, materials used for construction, and the plants and landscape features with which the devices are used

The feeding device with an inner liner may be used in a variety of different applications and in different settings to help retain moisture, prevent compost erosion, and/or reduce weeds. In some applications, once the planting material has been released into the planting sleeve, the feeding device may be placed in a desired planting location to add the benefits of planting material (e.g., compost, fertilizer, soil amendments, soil supplements, and/or other materials) to trees and other plants. For example, a woven water permeable feeding device may include an inner liner filled with compost, fertilizer, or other plant enhancing materials. The feeding device may be placed around a tree or other plant as a top dressing or side dressing for flowers, vegetables, or other vegetation. Water may be applied to incorporate the planting material into the soil. In preferred embodiments, feeding devices may be constructed of flexible woven material and used around row crops, larger trees, vegetables, flowers, and other plants.

In other possible applications, the feeding device may be filled with planting mix (or other plant growing media), as well as flower starts or seeds for direct planting of flowers. Such devices allow the user to add color around trees and other landscape features. In yet other applications, the feeding device may be filled with seeds and planting mix (or other plant growing media), and placed in the desired location to start a vegetable garden. Such feeding devices may offer an effective way to build seasonal raised planting beds or garden borders in a desired area, such as in areas where soil or landscape conditions might make the introduction of such plantings otherwise difficult, labor-intensive, or time-intensive. As an example, the feeding device may be filled with soil, potting mix, planting mix, or other plant growing media and planted with flower, plant, or shallow root vegetable seeds that are allowed to grow through openings along the surface of the device. The planting devices may be placed where a user would like to plant a vegetable garden or to add color to an area with flower starts or seeds that are placed within the feeding device.

As discussed, the incorporation of an inner liner may be useful in helping to increase the shelf-life of a planting sleeve, feeding bag, and/or other feeding devices, particularly those made of biodegradable woven fabric, such as burlap or other biodegradable material. It will be appreciated, however, the inner liner may be used with a wide variety of different feeding device materials. In some embodiments, the feeding devices may be constructed of non-woven polypropylene fabric or other fabrics known in the art for enhanced durability and strength. Such feeding devices may be used to introduce vegetation, such as a garden borders or raised garden beds, in urban areas or other desired settings. The feeding devices may have sufficient strength to be relocated after planting. Such materials may be particularly desirable in applications that allow for extended use, and/or maintenance, or those that call for extended re-use of the feeding device.

Although described above as being constructed in particular shapes, the feeding devices and inner liners described above may be constructed in a range of customizable shapes, configurations, and relative dimensions. As non-limiting examples, the feeding devices and inner liners may be substantially elongated, linear, tube-shaped, ring-shaped, rectangular, square, hexagonal, round, or irregular in shape, or the feeding devices may have a combination of different shapes or different shaped segments arranged together. The devices may include relatively straight edges. Alternatively, the feeding devices may include curved or rounded edges that form a substantially circular, substantially rounded, or substantially oval shape. In yet other embodiments, the feeding devices may include a combination of relatively straight edges and curved or rounded edges.

Although the inner liner is described in some examples above as being made of plastic, the inner liner may be constructed of any suitable material that can provide a barrier between the feeding device and the filler media contained within the feeding device, and can allow the inner liner to retain all or at least most of the filler media within the feeding device. It also may be desired that the feeding device material have sufficient strength to allow for transportation and storage of the material over time, as well as easy removal from the feeding device. The ordinary artisan will recognize that other materials commonly used in applications involving plant growth, maintenance, soil enhancement, and erosion control can be employed for the inner liner. The selection of the material may vary depending on factors such as, without limitation: the desired weight, flexibility, strength, longevity, permeability, volume of anticipated filler media, storage capacity, the anticipated application, and/or the desired size of the feeding device.

In some embodiments, the inner liner may be reusable and/or resealable to allow for replacement or multiple uses. The planting sleeve also may be reusable and/or resealable to allow for replacement or multiple uses. Among its features, the inner liner may also provide one or more spaces for labeling or for incorporating graphics, text, or information onto the feeding devices. The inner liner may also be compatible for use with different feeding devices and replaced, for example, if a different filler media is desired.

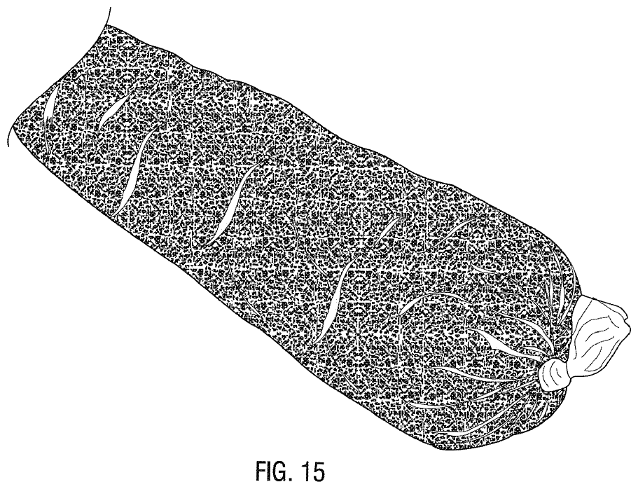

One or both ends of the inner liner may be closed or otherwise formed into the desired shape using one or more of any closure methods and/or structures (or combination of closure structures) known in the art for sealing or shaping flexible materials. These include, without limitation: knotting, tying, sewing, stitching, weaving, stapling (e.g., with mild steel staples), gluing, using flaps, fasteners, Velcro, hooks, snaps, glue, interconnecting parts, ties, string, twine, hook and loop fasteners, other fasteners, elastic, tensioners, locks, latches, complementary grooves and notches, protrusions, pegs, adhesives, pins, buttons, snaps, snap-in connectors, twist-on fittings, screws, mechanical fittings, other mechanical closures, and/or other closure structures and connecting methods. FIG. 15 illustrates an inner liner that is knotted at and end of the bag to reduce of the loss of material at the end.

In addition, the ends of the feeding devices, planting sleeves, and/or feeding bags may be closed or otherwise formed into the desired shape using one or more one or more of any methods and closure structures (or combination of closure structures) known in the art for securing materials, such as inner liners and planting material, within planting fabrics and other plant-growing materials. These include, without limitation: knotting, tying, sewing, stitching, weaving, stapling (e.g., with mild steel staples), gluing, using flaps, fasteners, Velcro, hooks, snaps, glue, interconnecting parts, ties, string, twine, hook and loop fasteners, other fasteners, elastic, tensioners, locks, latches, complementary grooves and notches, protrusions, pegs, adhesives, pins, buttons, snaps, snap-in connectors, twist-on fittings, screws, mechanical fittings, or mechanical closures, and/or other closure structures and connecting methods.

The above disclosures are sufficient to enable one of ordinary skill in the art to practice the invention, and provide the best mode of practicing the invention presently contemplated by the inventor. While there is provided herein a full and complete disclosure of specific embodiments of this invention, it is not desired to limit the invention to the exact construction, dimensional relationships, and operation shown and described. Various modifications, alternative constructions, design options, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed is:

1. An apparatus for feeding a plant, comprising:
(a) an outer casing comprising
(i) an interior cavity and
(ii) an outer casing opening disposed at an end of the outer casing and providing access into the interior cavity,
(b) an inner casing disposed within the interior cavity of the outer casing; and
(c) planting media disposed within the inner casing;
wherein the outer casing opening permits removal of the inner casing from the interior cavity, while leaving the planting media within the interior cavity.

2. The apparatus of claim 1, wherein the inner casing comprises an inner casing opening disposed at an end of the inner casing opposite from the outer casing opening, and the inner casing opening permits release of the planting media from the inner casing.

3. The apparatus of claim 1, wherein the outer casing further comprises a closure member disposed at the end of the outer casing.

4. The apparatus of claim 1, wherein the outer casing comprises a substantially tubular shape.

5. The apparatus of claim 1, wherein the outer casing comprises a substantially ringed shape.

6. The apparatus of claim 1, wherein the outer casing comprises a substantially water permeable enclosure.

7. The apparatus of claim 1, wherein the planting media comprises at least one of the following: compost, fertilizer, or soil.

8. An apparatus for feeding a plant comprising:
(a) an outer enclosure comprising:
(i) an interior cavity and
(ii) an access opening at an end of the outer enclosure and providing passage into the interior cavity; and
(b) an inner enclosure dimensioned to fit through the access opening and within the interior cavity of the outer enclosure; the inner enclosure comprising a release opening at an end of the inner enclosure.

9. The apparatus of claim 8, further comprising planting media disposed within the inner enclosure.

10. The apparatus of claim 9, wherein the inner enclosure is fit within the interior cavity of the outer enclosure, and the release opening is positioned opposite from the access opening.

11. The apparatus of claim 9, wherein the inner enclosure is fit within the interior cavity of the outer enclosure, and the inner enclosure is adapted to be removed from the interior cavity, while leaving the planting media within the interior cavity via the release opening.

12. The apparatus of claim 8, wherein the outer enclosure further comprises a closure member disposed near the access opening of the outer enclosure.

13. The apparatus of claim 8, wherein the outer enclosure comprises a substantially tubular shape.

14. The apparatus of claim 8, wherein the outer enclosure comprises a substantially ringed shape.

15. A method of feeding plants comprising:
(a) securing a feeding assembly, the feeding assembly comprising:
(i) a first end,
(ii) a second end opposite from the first end,
(iii) an outer casing aligned with the first and second ends of the feeding assembly and comprising an interior cavity,
(iv) an inner casing disposed within the interior cavity and aligned with the first and second ends of the feeding assembly, and
(v) planting media disposed within the inner casing;
(b) opening the inner casing at the first end of the feeding assembly to permit release of the planting material from the inner casing;
(c) opening the outer casing at the second end of the feeding assembly to permit removal of the inner casing from the feeding assembly;
(d) removing the inner casing from the feeding assembly through the opened outer casing, while releasing the planting media through the opened inner casing and into the interior cavity of the outer casing; and
(e) positioning the feeding assembly with released planting media in a desired area.

16. The method of claim 15, wherein the feeding assembly comprises a substantially tubular shape.

17. The method of claim 15, wherein the feeding assembly comprises a substantially ringed shape.

18. The method of claim 15, wherein the feeding assembly further comprises a closure member adapted to substantially close the outer casing at the second end.

19. The method of claim 15, further comprising the steps of: opening the outer casing at the first end to permit the opening of the inner casing, and closing the outer casing at the first end after the inner casing has been opened.

20. The method of claim 15, wherein the planting media comprises at least one of the following: compost, fertilizer, or soil.
